(19) United States
(12) Patent Application Publication
(10) Pub. No.: US 2013/0080444 A1
(43) Pub. Date: Mar. 28, 2013

(54) Chart Recommendations

(71) Applicants: Robin Wakefield, Seattle, WA (US); Nick Chiang, Redmond, WA (US)

(72) Inventors: Robin Wakefield, Seattle, WA (US); Nick Chiang, Redmond, WA (US)

(73) Assignee: Microsoft Corporation, Redmond, WA (US)

(21) Appl. No.: 13/245,126

(22) Filed: Sep. 26, 2011

(51) Int. Cl. G06F 17/30

(52) U.S. Cl. 707/748; 707/E17.084

(57) ABSTRACT

Chart recommendations may be provided. First, a summary of a dataset may be determined and each column and row in the dataset, based on the summary, may be classified into classifications. Next, based upon the classifications of each column and row in the dataset, the dataset may be mapped to a plurality of chart types. Each of the plurality of chart types may then be ranked.

### BACKGROUND

A chart is a graphical representation of data where data is represented by symbols, such as bars in a bar chart, lines in a line chart, or slices in a pie chart. A chart can represent tabular numeric data, functions, or some kinds of qualitative structures. Charts are often used to ease understanding of large quantities of data and the relationships between parts of the data. Charts can usually be read more quickly than the raw data that they are produced from.

### SUMMARY

Chart recommendations may be provided. This Summary is provided to introduce a selection of concepts in a simplified form that are further described below in the Detailed Description. This Summary is not intended to identify key features or essential features of the claimed subject matter. Nor is this Summary intended to be used to limit the claimed subject matter's scope.

Chart recommendations may be provided. First, a summary of a dataset may be determined and each column and row in the dataset, based on the summary, may be classified into classifications. Next, based upon the classifications of each column and row in the dataset, the dataset may be mapped to a plurality of chart types. Each of the plurality of chart types may then be ranked.

Both the foregoing general description and the following detailed description provide examples and are explanatory only. Accordingly, the foregoing general description and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present invention. In the drawings:

FIG. 1 is a block diagram of an operating environment;

FIG. 2 is a flow chart of a method for providing chart recommendations;

FIG. 3 is a diagram illustrating a first user interface;

FIG. 4 is a diagram illustrating a second user interface; and

FIG. 5 is a block diagram of a system including a computing device.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

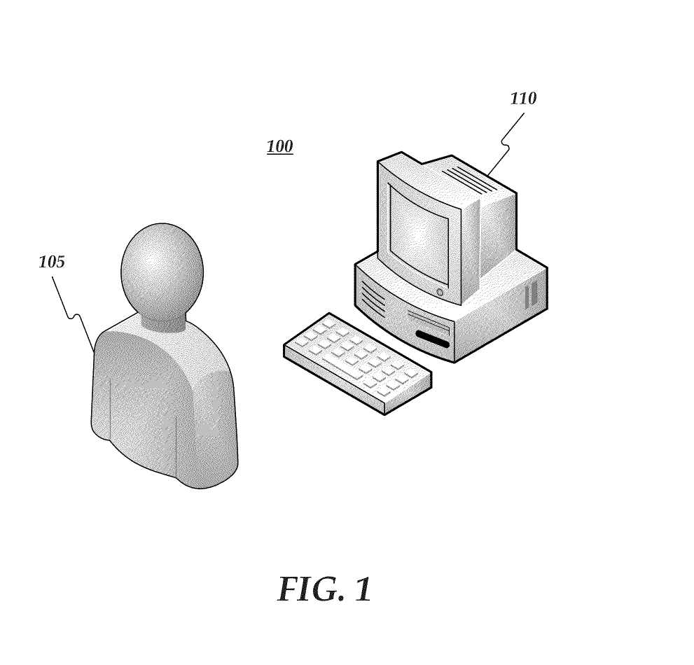

FIG. 1 is a block diagram of an operating environment 100. Operating environment 100 may include a user 105 and a computing device 110. Interacting with computing device 110, user 105 may create a summary table comprising a user dataset. After creating the summary table, user 105 may wish to create a visualization showing the user data set on computing device 110. Unfortunately, user 105 may not understand the difference between the available choices for data visualization and may struggle to get a visualization that shows the data correctly.

Consistent with embodiments of the invention, chart recommendations may be provided utilizing, for example, a method for providing chart recommendations. The method for providing chart recommendations may receive the user dataset provided by user 105. Then the method for providing chart recommendations may heuristically determine a set of appropriate chart suggestions, taking into account different chart types, data mappings and chart layouts, based on the given user dataset. This may significantly simplify chart creation for user 105 when compared to conventional systems.

In order to provide a chart recommendation, the method for providing chart recommendations may actively parse the user dataset. By actively parsing the user dataset and understanding its contents and how it is laid out, the method for providing chart recommendations may help users quickly identify suitable chart types and appropriate ways of mapping their data to the chart, thereby simplifying the chart creation process.

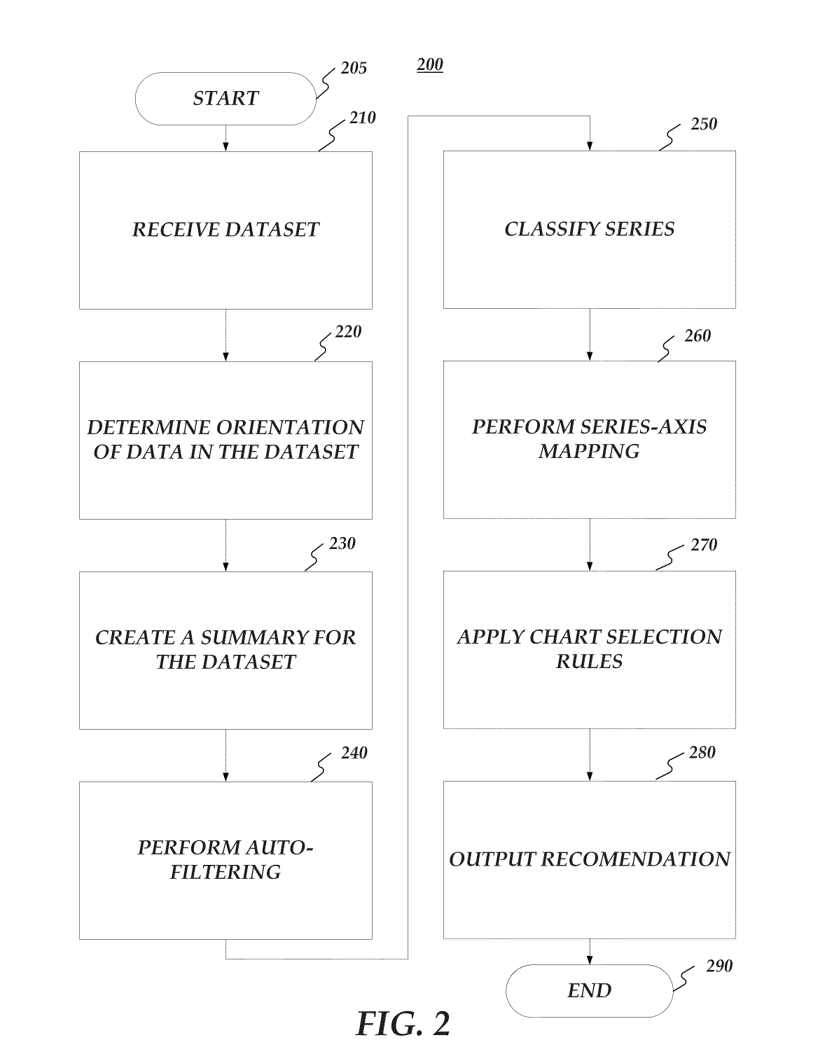

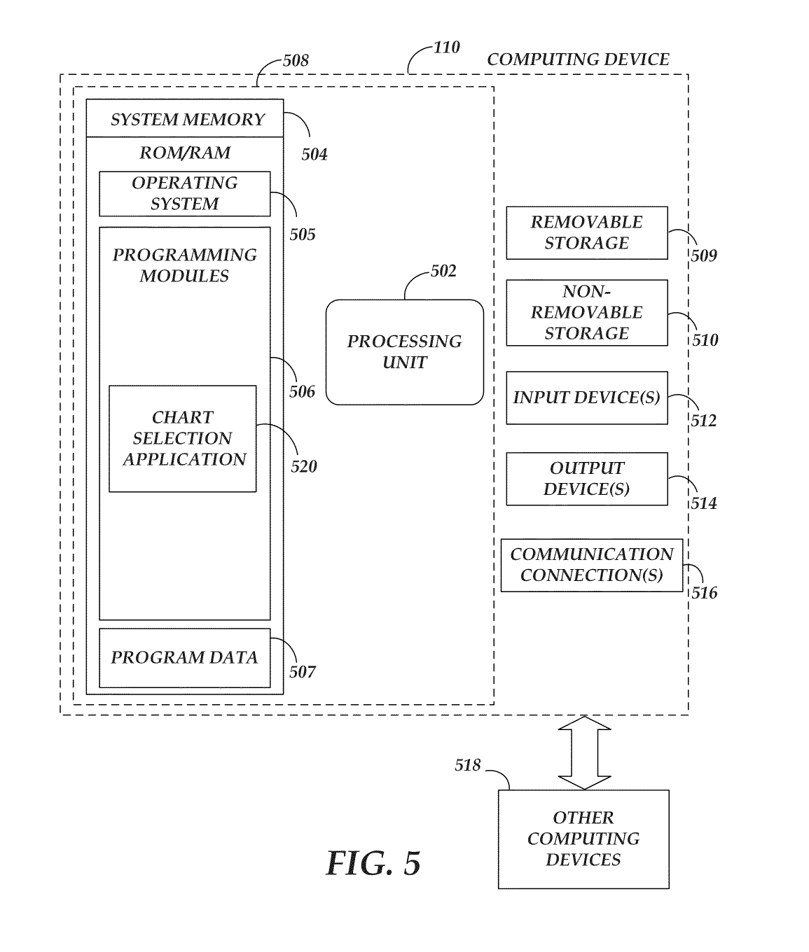

FIG. 2 is a flow chart setting forth the general stages involved in a method 200 consistent with an embodiment of the invention for providing chart recommendations. Method 200 may be implemented using computing device 110 as described in more detail below with respect to FIG. 5 and above with respect to FIG. 1. Ways to implement the stages of method 200 will be described in greater detail below.

Method 200 may begin at starting block 205 and proceed to stage 210 where computing device 110 may receive a dataset. For example, user 105 may interact with computing device 110 to create a summary table comprising the dataset. The summary table may be created by user 105 within, for example, a spreadsheet application program. The summary table may be created in any way and is not limited to a spreadsheet application program.

From stage 210, where computing device 110 receives the dataset, method 200 may advance to stage 220 where computing device 110 may determine an orientation of the dataset. For example, computing device 110 may heuristically determine whether the dataset is laid out, for example, in a “column-wise” orientation or a “row-wise” orientation. One orientation may then be ranked higher than the other. In other words, computing device 110 may determine the orientation of the data in the dataset that may affect how the data in the dataset is latter viewed (e.g. vertically or horizontally.)

Once computing device 110 determines the orientation of the dataset in stage 220, method 200 may continue to stage 230 where computing device 110 may create a summary for the dataset. For example, looking at the dataset, computing device 110 may compile together a set of attributes off of which chart selection rules may latter be based. This may be done for each orientation (e.g. attributes may be compiled for each row and for each column in the dataset.)

In determining attributes, computing device 110 may determine for every single row and for every single column of the data set attributes, for example: i) the average of all the values in a particular row or column; ii) what the maximum value is in a particular row or column; iii) what the minimum value is in a particular row or column; iv) are all the contents strings in a particular row or column; and v) are all the contents dates in a particular row or column.

After computing device 110 creates the summary for the dataset in stage 230, method 200 may proceed to stage 240 where computing device 110 may perform auto-filtering of the dataset. In certain cases with more complex datasets, computing device 110 may heuristically determine, for example, which categories and value series are important to include and which ones should be left out. For example, in stage 210, user 105 may create the summary table comprising the dataset by selecting the entire data range of the summary table or user 105 may select the summary table comprising a single cell. In the latter case, computing device 110 may find the balance of the data in the single cell's range in order to create the dataset. In doing so, computing device 110 may determine the value of the data in that range. Moreover, computing device 110 may filter out columns that may not contribute to a good chart in the end. For example, computing device 110 may filter out columns interspersed in the summary table that do not contribute to a good chart in the end.

From stage 240, where computing device 110 performs auto-filtering of the dataset, method 200 may advance to stage 250 where computing device 110 may classify series in the dataset. With the dataset summaries (e.g. one for each orientation) created in stage 230, computing device 110 may walk through each series in the dataset to determine each series' classification (e.g. a categorical series, a value series, or a header.) In other words, after the attributes for each row and column are determined, computing device 110 run through a set of rules to determine whether a particular row or column is better as a value series or a category series. Category series may be a title of a series and value series may hold actual numbers. For example, for every chart type supported, there may be a set of rules that define how categories, value series, and header should be identified. From the attributes generated in the dataset summary, computing device 110 may generate scores for each series in the dataset relating to how likely that series is a category versus a value series versus a header. This process is repeated across both a row-wise orientation and a column-wise orientation for all chart types. If at least one value series is not found, computing device 110 may not return any results. The scores used to classify series may not contribute to the final scores for suggesting charts.

The rules used to classify series may be logic functions based off of the attributes. For example, if the data type of the column is string because the values in a particular column are strings, then the column is more likely to be a category more to represent a title than numerical values in a chart. Furthermore, if a whole row comprises dates, then that tells something about what type of chart would make sense because they are all dates. The following is an example of rules for column and bar charts to determine if a column should be a category series versus a value series:

Category Series
If the series is the leftmost column, category series score +1
If the series has no null values, category series score +1
If the series is composed of string values:
If the number of distinct values is between 2 and 5, category series score +7
If the number of distinct values is between 6 and 16, category series score +9
If the number of distinct values is between 17 and 32, category series score +8
If the number of distinct values is between 33 and 50, category series score +2

Value Series
If the series is composed of numbers:
If the sum of the values total 1 or 100, value series score −1
If there are no null values, value series score +6
If the number of distinct values divided by the number of values is greater than or equal to 0.5, value series score +1
If the number of distinct values divided by the number of values is less than 0.5, value series score −1

Once computing device 110 classifies series in the dataset in stage 250, method 200 may continue to stage 260 where computing device 110 may perform mapping of the dataset. In particular, computing device 110 may run the categories and value series against a set of predetermined conditions for mapping those series to particular axis on a given chart type. For example, computing device 110 may run through every supported chart size and map what was determined in stage 250. So for a data set with a column that is all strings and then two columns with numbers, computing device 110 may map the string column to the category series and the two numerical columns to the value series of, for example, a column chart. For a pie chart, computing device 110 may map only the first value series column because you can only have a single value series mapped to a pie chart. For a scatter chart for example, computing device 110 may map two value series to represent the X and the Y attributes of the scatter chart. The chart types may comprise, but are not limited to, the following:

Column
Clustered Column Chart
Stacked Column Chart
100% Stacked Column Chart

Line
Line Chart
100% Stacked Line Chart

Pie
Pie Chart
Pie of Pie Chart
Bar of Pie Chart

Bar
Clustered Bar Chart
Stacked Bar Chart
100% Stacked Bar Chart

Area
Stacked Area Chart
100% Stacked Area Chart

Scatter
Scatter with only Markers Chart

Stock
High-Low-Close Chart
Open-High-Low-Close Chart
Volume-High-Low-Close Chart
Volume-Open-High-Low-Close Chart

Surface
3D Surface Chart
Contour

Doughnut
Doughnut Chart

Bubble
Bubble Chart

Radar
Radar Chart

Combination Charts
Clustered Column Chart+Line Chart

After computing device 110 performs mapping in stage 260, method 200 may proceed to stage 270 where computing device 110 may apply chart rules. For example, computing device 110 may run the mappings from stage 260 against chart selection rules to get a score of how appropriate a particular chart is. In other words, computing device 110 may look at the chart maps created in stage 260 and determine how good each chart is by ranking each mapping from stage 260 using chart rules.

The final chart suggestions may be ranked by computing device 110 from an internal rules-based scoring system. The scoring system may comprise two types of values: i) static scores; and ii) score multipliers. Static scores may be mapped against each individual chart selection rule that may determine how appropriate the set of categories and value series for a particular chart type and mapping are. Score multipliers may be mapped against the data orientation, series-axis mappings, and results filtering rules to provide a broader way to increase or decrease the scores for a group of suggestions. Both the static scores and score multipliers may be combined into the overall score for each chart suggestion.

The scores for each chart suggestion may be normalized against the total possible score for a particular chart type to get a score out of 100, with 100 representing the highest possible ranked suggestions and 0 representing the lowest possible ranked suggestion. The rules and score multipliers may push the scores above 100 or below 0. The following is an example of rules that determine the utility of a chart.

### Line Charts

If the category series is composed of either dates, years, days of the week or month names, chart score +25
If the category series is composed of strings and there are:
   between 3-8 values, chart score +35
   between 9-16 values, chart score +25
   between 17-32 values, chart score +20
   between 33-50 values, chart score +5
   more than 50 values, do nothing
If the value series is composed of numbers, chart score +5
If the ratio of null to non-null values in the chart is:
   greater than or equal to 0.7, chart score −40
   between 0.5 and 0.7, chart score −20
   between 0.3 and 0.5, chart score −10
   less than 0.3, chart score +15

### Clustered Bar Charts

If the category series is of type string and all its values are less than 16 characters long, chart score −5
If the category series is of type string and some of its values are greater than 16 characters long, chart score +10

### Pie Charts

If there is more than 1 value series, don't recommend a pie chart

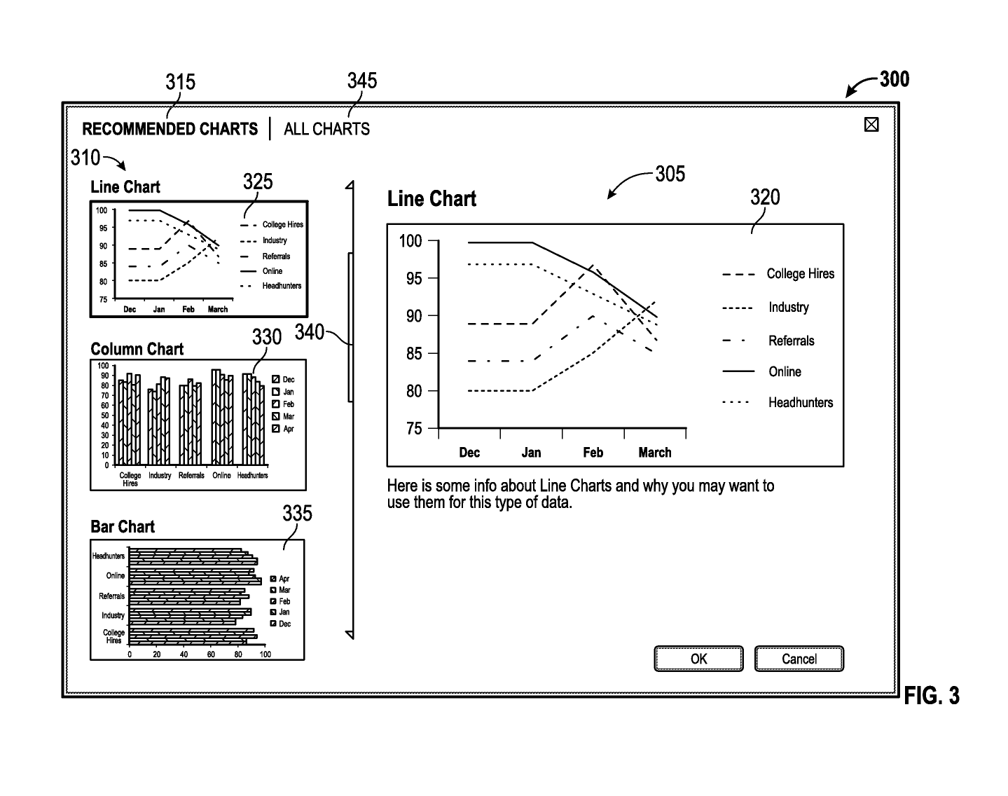

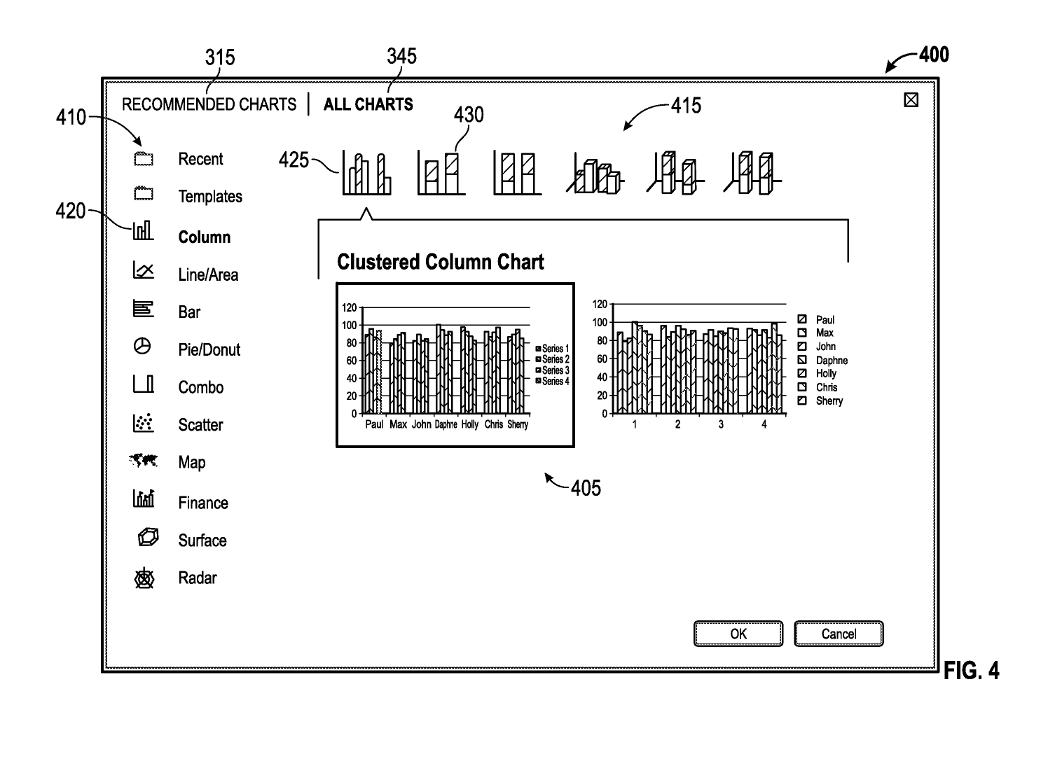

Once computing device 110 applies chart rules in stage 270, method 200 may continue to stage 280 where computing device 110 may output recommendations. For example, computing device 110 may output a stack ranked list of chart suggestions for the given dataset. In other words, for the dataset, a list of all chart types mapped in stage 260 in provided in an order ranked by the chart rule application from stage 270. Computing device 110 may provide this ranking to a user interface that my simply show the list to user 105. Or computing device 110 may provide a move visual representation through user interfaces as shown in FIG. 3 and in FIG. 4.

FIG. 3 shows a first user interface 300. As shown in FIG. 3, first user interface 300 may comprise a main display pane 305 and a side pane 310. When user 105 selects recommended charts button 315, the chart receiving the highest ranking from stage 270 may be displayed in main pane 305. Then, charts receiving subsequently lower scores may be shown in side pane 310. In other words, a first chart 320 may have received the highest ranking, a second chart 325 may have received the second highest ranking, a third chart 330 may have received the third highest ranking, and a fourth chart 335 may have received the fourth highest ranking. By providing user input to computing device 110 (e.g. by sliding a slide bar 340), user 105 may cause consecutive subsets of subsequently lower ranked charts to be displayed in side pane 310.

FIG. 4 shows a second user interface 400. By selecting an all charts button 345 from first user interface 300, user 105 may cause computing device 110 to display second user interface 400. As shown in FIG. 4, second user interface 400 may comprise a central display pane 405, a first area pane 410, and a second area pane 415. First area pane 410 may comprise a list of all types of supported available charts (e.g. all the chart types mapped in stage 260.) For a given chart type selected from first area pane 410, second area pane 415 may display any sub-types of the selected available charts. For example, user 105 may select column button 420 from first area pane 410. This may cause all the different types of available sub-types of column charts to be shown in second area pane 415. User 105 may select a clustered column chart to be displayed in central display pane 405 by selecting clustered column chart button 425 as shown in FIG. 4. By selecting a stacked column chart button 430 from second area pane 415, user 105 may cause computing device 110 to display a stacked column chart in central display pane 405. User 105 may toggle back to first user interface 300 by selecting recommended charts button 315 from second user interface 400. Once computing device 110 outputs recommendations in stage 280, method 200 may then end at stage 290.

An embodiment consistent with the invention may comprise a system for providing chart recommendations. The system may comprise a memory storage and a processing unit coupled to the memory storage. The processing unit may be operative to determine a summary of a dataset and to classify each column and row in the dataset, based on the summary, into classifications. Moreover, the processing unit may be operative to map, based upon the classifications of each column and row in the dataset, the dataset to a plurality of chart types. The processing unit may be further operative to rank each of the plurality of chart types.

Another embodiment consistent with the invention may comprise a system for providing chart recommendations. The system may comprise a memory storage and a processing unit coupled to the memory storage. The processing unit may be operative to classify each column and row in a dataset, based on a summary, into classifications and to map, based upon the classifications of each column and row in the dataset, the dataset to a plurality of chart types. Furthermore, the processing unit may be operative to rank each of the plurality of chart types and to display chart recommendations based upon the ranking of each of the plurality of chart types.

FIG. 5 is a block diagram of a system including computing device 110. Consistent with an embodiment of the invention, the aforementioned memory storage and processing unit may be implemented in a computing device, such as computing device 110 of FIG. 5. Any suitable combination of hardware, software, or firmware may be used to implement the memory storage and processing unit. For example, the memory storage and processing unit may be implemented with computing device 110 or any of other computing devices 518, in combination with computing device 110. The aforementioned system, device, and processors are examples and other systems, devices, and processors may comprise the aforementioned memory storage and processing unit, consistent with embodiments of the invention.

With reference to FIG. 5, a system consistent with an embodiment of the invention may include a computing device, such as computing device 110. In a basic configuration, computing device 110 may include at least one processing unit 502 and a system memory 504. Depending on the configuration and type of computing device, system memory 504 may comprise, but is not limited to, volatile (e.g. random access memory (RAM)), non-volatile (e.g. read-only memory (ROM)), flash memory, or any combination. System memory 504 may include operating system 505, one or more programming modules 506, and may include a program data 507. Operating system 505, for example, may be suitable for controlling computing device 110's operation. In one embodiment, programming modules 506 may include, for example, a chart recommendation application 520. Furthermore, embodiments of the invention may be practiced in conjunction with a graphics library, other operating systems, or any other application program and is not limited to any particular application or system. This basic configuration is illustrated in FIG. 5 by those components within a dashed line 508.

Computing device 110 may have additional features or functionality. For example, computing device 110 may also include additional data storage devices (removable and/or non-removable) such as, for example, magnetic disks, optical disks, or tape. Such additional storage is illustrated in FIG. 5 by a removable storage 509 and a non-removable storage 510. Computing device 110 may also contain a communication connection 516 that may allow computing device 110 to communicate with other computing devices 518, such as over a network in a distributed computing environment, for example, an intranet or the Internet. Communication connection 516 is one example of communication media.

The term computer readable media as used herein may include computer storage media. Computer storage media may include volatile and nonvolatile, removable and non-removable media implemented in any method or technology for storage of information, such as computer readable instructions, data structures, program modules, or other data. System memory 504, removable storage 509, and non-removable storage 510 are all computer storage media examples (i.e., memory storage). Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 110. Any such computer storage media may be part of device 500. Computing device 110 may also have input device(s) 512 such as a keyboard, a mouse, a pen, a sound input device, a touch input device, etc. Output device(s) 514 such as a display, speakers, a printer, etc. may also be included. The aforementioned devices are examples and others may be used.

The term computer readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

As stated above, a number of program modules and data files may be stored in system memory 504, including operating system 505. While executing on processing unit 502, programming modules 506 (e.g. chart recommendation application 520) may perform processes including, for example, one or more method 200's stages as described above. The aforementioned process is an example, and processing unit 502 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Embodiments of the invention may be practiced via a system-on-a-chip (SOC) where each or many of the components illustrated in FIG. 5 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the invention, may be performed via application-specific logic integrated with other components of computing device 110 on the single integrated circuit (chip). Moreover, the components illustrated in FIG. 5 may be practiced, for example, in a mobile device or in a cloud computing system.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

All rights including copyrights in the code included herein are vested in and the property of the Applicant. The Applicant retains and reserves all rights in the code included herein, and grants permission to reproduce the material only in connection with reproduction of the granted patent and for no other purpose.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

1. A method for providing chart recommendations, the method comprising:
determining a summary of a dataset;
classifying each column and row in the dataset, based on the summary, into classifications;
mapping, based upon the classifications of each column and row in the dataset, the dataset to a plurality of chart types; and
ranking each of the plurality of chart types based on an analysis of each chart type's representation of the dataset.

2. The method of claim 1, wherein determining the summary of the dataset comprises determining a plurality of attributes for the dataset.

3. The method of claim 1, wherein determining the summary of the dataset comprises determining a plurality of attributes for each column and for each row of the dataset.

4. The method of claim 1, wherein determining the summary of the dataset comprises determining a plurality of attributes for each column and for each row of the dataset, the plurality of attributes comprising ones of the following: an average of all values in a row; an average of all values in a column; a maximum value in row; a maximum value in column; a minimum value in a row; a minimum value in a column; a determination that all values in a row are strings; a determination that all values in a column are strings; a determination that all values in a row are dates; and a determination that all values in a column are dates.

5. The method of claim 1, wherein classifying each column and row in the dataset, based on the summary, into classifications comprises classifying each column and row in the dataset into classifications comprising ones of the following: a category series, a value series, and a header.

6. The method of claim 1, wherein ranking each of the plurality of chart types comprising using a scoring system comprising at least one type of value comprising one of: static scores and score multipliers.

7. The method of claim 1, wherein ranking each of the plurality of chart types comprising using a scoring system comprising two types of values comprising static scores and score multipliers.

8. The method of claim 6, wherein using the scoring system comprising the static scores comprises mapping the static scores against each individual chart selection rule to determine how appropriate a set of categories and value series for a particular chart type and mapping are.

9. The method of claim 6, wherein using the scoring system comprising the score multipliers comprises mapping the score multipliers against a data orientation, series-axis mappings, and results filtering rules to one of increase and decrease a scores for a group of suggestions.

10. The method of claim 1, further comprising receiving the dataset.

11. The method of claim 1, further comprising determining an orientation of the dataset.

12. The method of claim 1, further comprising determining an orientation of the dataset, the orientation comprising one of the following: column-wise orientation and row-wise orientation.

13. The method of claim 1, further comprising filtering the dataset.

14. The method of claim 1, further comprising filtering the dataset wherein filtering the dataset comprises:
determining that at least one of the following would not contribute to a good chart: at least one column and at least one row; and
excluding from the dataset at least one of the following: the determined at least one column and the determined at least one row.

15. A computer-readable storage medium that stores a set of instructions which when executed perform a method for providing chart recommendations, the method executed by the set of instructions comprising:
classifying each column and row in a dataset, based on a summary, into classifications;
mapping, based upon the classifications of each column and row in the dataset, the dataset to a plurality of chart types;
ranking each of the plurality of chart types based on an analysis of each chart type's representation of the dataset; and
displaying chart recommendations based upon the ranking of each of the plurality of chart types.

16. The computer-readable storage medium of claim 15, wherein displaying the chart recommendations comprises displaying a highest ranked chart in a main pane.

17. The computer-readable storage medium of claim 16, wherein displaying the chart recommendations comprises displaying ones of a subset of subsequently ranked charts in a side pane.

18. The computer-readable storage medium of claim 15, wherein displaying the chart recommendations comprises:
displaying a highest ranked chart in a main pane;
displaying ones of a subset of subsequently ranked charts in a side pane; and
displaying ones of another subset of subsequently ranked charts in the side pane in response to user input.

19. The computer-readable storage medium of claim 18, wherein displaying the chart recommendations comprises:
displaying a list of supported available chart types in a first area pane;
displaying a list of sub-types in a second area pane, the list of sub-types corresponding to a selected one of the supported available chart types in the first area pane; and
displaying a chart corresponding to the selected one of the supported available chart types in the first area pane and a selected one of the sub-types in the second area pane.

20. A system for providing chart recommendations, the system comprising:
a memory storage; and
a processing unit coupled to the memory storage, wherein the processing unit is operative to:
receive a dataset;
determine an orientation of the dataset, the orientation comprising one of the following: column-wise orientation and row-wise orientation;
determine a summary of the dataset based at least upon the determined orientation, wherein determining the summary of the dataset comprises determining a plurality of attributes for each column and for each row of the dataset;
filter the dataset, wherein the processing unit being operative to filter the dataset comprises the processing unit being operative to,
determine that at least one of the following would not contribute to a good chart: at least one column and at least one row, and
exclude from the dataset at least one of the following: the determined at least one column and the determined at least one row;
classify each column and row in the filtered dataset, based on the summary, into classifications wherein the processing unit being operative to classify each column and row in the filtered dataset comprises the processing unit being operative to classify each column and row in the filtered dataset, based on the summary, into classifications comprises classifying each column and row in the filtered dataset into classifications comprising ones of the following: a category series, a value series, and a header;
map, based upon the classification of each column and row in the filtered dataset, the filtered dataset to a plurality of chart types;
rank each of the plurality of chart types, wherein the processing unit being operative to rank each of the plurality of chart types comprising the processing unit being operative to analyze each chart type's representation of the dataset; and
display chart recommendations based upon the ranking of each of the plurality of chart types wherein the processing unit being operative to display chart recommendations comprises the processing unit being operative to,
display a highest ranked chart in a main pane, and
display ones of a subset of subsequently ranked charts in a side pane.
